(19) United States
(12) Patent Application Publication
(10) Pub. No.: US 2019/0367343 A1
(43) Pub. Date: Dec. 5, 2019

(54) BELL CORK REMOVER

(71) Applicant: Universidad Nacional del Este-Facultad Politecnica, Ciudad del Este-Alto Parana (PY)

(72) Inventors: Carlos Domingo ALMEIDA DELGADO, Ciudad del Este Alto Parana (PY); Hector David Ferreira Brizuela, Ciudad del Este Alto Parana (PY); Clara Isabel Arevalos Silvero, Minga Guazu Alto Parana (PY); Katia Andrea Ayala Diaz, Ciudad del Este Alto Parana (PY)

(21) Appl. No.: 16/030,565

(22) Filed: Jul. 9, 2018

(30) Foreign Application Priority Data
May 31, 2018 (PY) P 1841302

(51) Int. Cl. B67B 7/06

(52) U.S. Cl. CPC B67B 7/06

(57) ABSTRACT

Device for removing a cork from a bottle comprising an outer body that houses a plurality of mechanisms configured to move a needle, such that the needle comprises tabs in the tip, such that the tabs are configured to separate from the tip of the needle when said tip of the needle has passed through the cork in its entirety, such that the plurality of mechanisms comprises a horizontal bevel gear, two vertical bevel gears connected to the horizontal bevel gear, and a cogwheel joined axially to each vertical bevel gear, wherein the needle comprises two racks that are in contact with the cogwheels, such that the movement of the cogwheels moves the needle.

### CROSS REFERENCE TO RELATED APPLICATION

This application claims priority of Paraguay Application No. P 1841302 PY filed May 31, 2018, application which is incorporated herein by reference.

### FIELD OF THE INVENTION

The present invention relates to a device for removing the cork from a bottle, without exerting any force and which offers an important conceptual difference with respect to other similar devices, since it does not introduce a helical element through the cork, meaning the cited cork undergoes less damage during the removal thereof.

### BACKGROUND OF THE INVENTION

The classic mechanism for removing the cork from the wine bottle is based on a metal in the shape of a metal spiral that is introduced into the cork of the bottle and once a suitable depth is reached, the cork is pulled with a handle, completely removing it from the bottle. However, this way of removing the cork from the wine bottle requires making an effort that at times is excessive, thus making the removal without damaging the cork and at times, even the wine bottle, impossible.

An improvement of this corkscrew consists of the metal spiral being joined to a support piece, at one end thereof, such that the support piece rests on the neck of the bottle and, by acting as a lever the cork is pulled, completely removing it from the bottle, meaning the force to be performed is reduced since instead of pulling outwards from the bottle, a lever force is performed towards the bottle itself.

There are novel corkscrews that propose a mechanism made up of a handle and a bottle holder, such as the one disclosed by document U.S. Pat. No. 4,703,673 where it is proposed that the cork be extracted by first introducing a metal spiral and then removing the cork with the handle.

In document U.S. Pat. No. 6,073,519 a corkscrew is proposed with a helical rod that is introduced through the cork of the wine bottle by means of a lateral lever, and the cork is removed by moving the lever in the opposite direction, assisted by internal springs.

Document U.S. Pat. No. 6,223,626 proposes a cork remover that injects air through the cork to the wine bottle by means of a needle, and subsequently removes the cork assisted by the pressure of the air introduced into the wine bottle.

Document U.S. Pat. No. 6,622,595 is also known which discloses a corkscrew consisting of a needle through which a fluid is injected inside the wine bottle, facilitating the removal of the cork by means of the pressure exerted by the fluid introduced inside the wine bottle.

Document U.S. Pat. No. 6,752,041 B2 discloses an electric corkscrew consisting of a metal spiral that is introduced through the cork of the wine bottle assisted by an electric motor that makes the spiral rotate in a positive direction in order to introduce it into the wine bottle and in a negative direction in order to remove the cork from the wine bottle.

Document U.S. Pat. No. 6,779,213 B2 discloses a cork remover that possesses a rotating head that is in turn connected to a smaller rotating head that makes a metal spiral rotate introducing it inside the cork of the wine bottle and, by rotating it in the opposite direction, the cork is removed from inside the wine bottle since it has a special mechanism that prevents the metal spiral from rotating in the opposite direction, freeing the cork again.

Document U.S. Pat. No. 9,850,116 B2 discloses a corkscrew in the shape of a bullet that has a compartment that enables a metal spiral to be uncovered which is introduced into the cork of the wine bottle, and, by means of a lever included in the device, it enables the cork to be removed from the wine bottle, one portion supporting the bottle and the cork is removed with the other end.

The present proposal consists of a cork remover in the shape of a bell, the inside of which has gears, the purpose of which is to reduce the force necessary to remove the cork, facilitating the task of the users that need to uncork the wine bottle and with a mechanism in the tip that facilitates the removal of the cork without effort.

### DESCRIPTION OF THE INVENTION

The device for removing a cork from a bottle object of the invention has an outer body that houses a plurality of mechanisms configured to move a needle, such that the needle comprises tabs in the tip, wherein the tabs are configured to separate from the tip of the needle when said tip of the needle has passed through the cork in its entirety.

In the device for removing a cork from a bottle object of the invention the plurality of mechanisms comprises a horizontal bevel gear, two vertical bevel gears connected to the horizontal bevel gear, and a cogwheel joined axially to each vertical bevel gear.

In the device for removing a cork from a bottle object of the invention the needle comprises two racks that are in contact with the cogwheels such that the movement of the cogwheels moves the needle.

In the device for removing a cork from a bottle object of the invention the outer body comprises a mobile upper casing, which acts as a support for the horizontal bevel gear and a fixed portion that acts as a support for the two vertical bevel gears.

In the device for removing a cork from a bottle object of the invention the needle comprises magnets and a hinge in the tip, such that the hinge comprises a number of springs, wherein the springs open when the rod presses with enough force to overcome the attraction of the magnets on the tabs.

The needle of the device for removing a cork from a bottle object of the invention comprises a hollow linear body that houses in the interior thereof a piston, a hydraulic chamber and a metal rod, wherein the piston presses on the hydraulic chamber which in turn presses on the metal rod, such that the metal rod presses, in turn, on the tabs in order to overcome the force of the magnets and open the tabs.

The device for removing a cork from a bottle object of the invention comprises a button in the mobile upper casing connected to the piston housed in the needle.

The device for removing a cork from a bottle comprises a support body configured to receive the end of a bottle where the cork is found, wherein the support body is situated on the hollow linear body between the tip of the needle and the racks.

### BRIEF DESCRIPTION OF THE DRAWINGS

What follows is a very brief description of a set of drawings that aid in better understanding the invention, and which are expressly related to an embodiment of said invention that is presented by way of a non-limiting example of the same.

FIG. 1 shows a perspective view of the device for removing the cork from a bottle showing the components of the device.

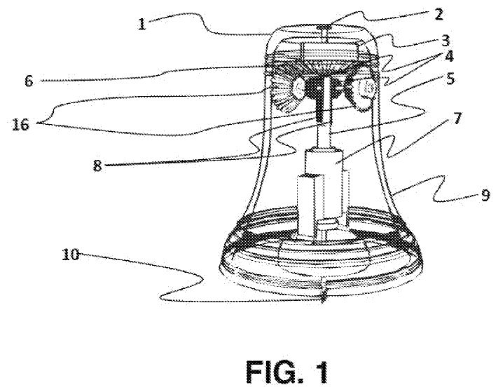

FIG. 2 shows a perspective view of the inside of the bell showing the mechanisms that introduce the needle inside the cork.

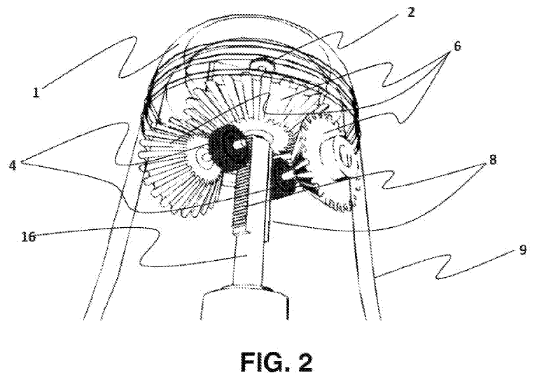

FIG. 3 shows a view of the inner portion of the device for removing the cork from a bottle with the actuation piston of the tip of the needle.

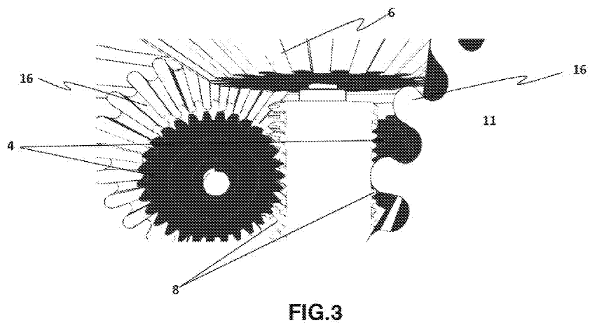

FIG. 4 shows a perspective view of the central portion of the device for removing the cork from a bottle seen from above.

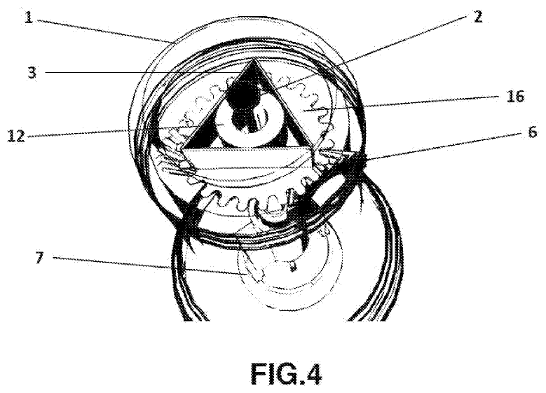

FIG. 5 shows a side view of the tip of the needle.

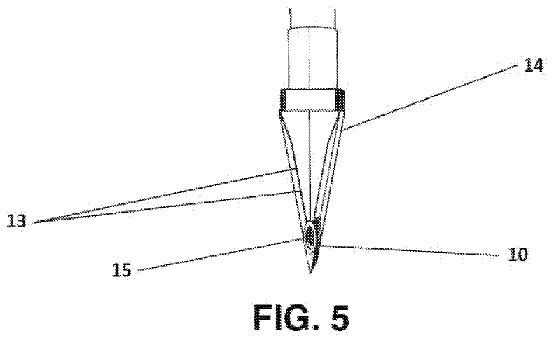

FIG. 6 shows a side view of the tip of the needle once the tabs are opened.

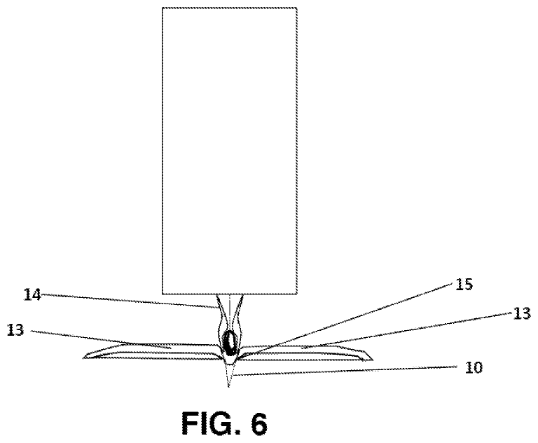

### DETAILED DESCRIPTION OF THE INVENTION

The object of the invention is a device for removing the cork from a bottle comprising an outer body that houses a plurality of mechanisms configured to move a needle (5) and introduce it into the cork, such that the tip (10) of the needle (5) has tabs (13) that separate from the tip of the needle (5) when said tip (10) of the needle (5) has passed through the cork in its entirety. Once the tabs (13) have been separated, the mechanisms move the needle (5) in the opposite direction, meaning towards the inside of the outer body, thus removing the cork from the bottle.

The plurality of mechanisms of the device object of the invention comprise:
a horizontal bevel gear (6),
two vertical bevel gears (16) connected to the horizontal bevel gear (6), and
a cogwheel (4) joined axially to each vertical bevel gear (16).

With the previous configuration, the movement of the horizontal bevel gear (6) is transferred to the vertical bevel gears (16) which in turn move the two cogwheels (4), and the movement of the cogwheels (4) moves the needle (5), since said needle (5) comprises two racks (8) that are in contact with the cogwheels (4).

The outer body comprises a mobile upper casing (1), which acts as a support for the horizontal bevel gear (6) and a fixed portion (9) that acts as a support for the two vertical bevel gears (16).

A transition piece (3) is located between the horizontal bevel gear (6) and the mobile upper casing (1) joining the horizontal bevel gear (6) to the mobile upper casing (1), while the transition piece (3) is joined to a mobile shaft (12) by which the horizontal bevel gear (6) rotates.

The needle (5) of the device object of the invention comprises a hollow linear body (17) the inside of which houses a piston (11) tasked with pressing on a hydraulic chamber (not shown) located inside the hollow linear body (17) which in turn presses on a metal rod (not shown) that acts to open the tabs (13) situated in the tip (10) of the needle (5), as will be explained later in this specification.

In the mobile upper casing (1) of the device object of the invention there is a button (2) which is connected to the piston (11) housed in the needle (5).

The needle (5) has in the lower end thereof a system made up of the tabs (13), magnets (14) a hinge (15) and a tip. The hinge (15) consists of a cylinder that has springs to facilitate the opening of the tabs (13), the springs open upon feeling the pressure of the rod with enough force to overcome the attraction of the magnets (14) on the tabs (13) and assisted by the springs of the hinge (15).

The device object of the invention comprises a support body (7) situated on the hollow linear body (17) of the needle (5), such that the support body (17) is configured to receive the end of a bottle where the cork is found.

In the preferred embodiment of the device object of the invention the support body (7) is situated on the hollow linear body (17) between the tip (10) of the needle (5) and the racks (8).

1. A device for removing a cork from a bottle, comprising an outer body that houses a plurality of mechanisms configured to move a needle, such that the needle comprises tabs in the tip, such that the tabs are configured to separate from the tip of the needle when said tip of the needle has passed through the cork in its entirety.

2. The device for removing a cork from a bottle according to claim 1, wherein the plurality of mechanisms comprises:
a horizontal bevel gear;
two vertical bevel gears connected to the horizontal bevel gear; and
a cogwheel joined axially to each vertical bevel gear;
wherein the needle comprises two racks that are in contact with the cogwheels, such that the movement of the cogwheels moves the needle.

3. The device for removing a cork from a bottle according to claim 1, wherein the outer body comprises a mobile upper casing, which acts as a support for the horizontal bevel gear and a fixed portion that acts as a support for the two vertical bevel gears.

4. The device for removing a cork from a bottle according to claim 1, wherein the needle in the tip comprises magnets and a hinge, such that the hinge comprises springs to facilitate the opening of the tabs, wherein the springs open when the rod presses with enough force to overcome the attraction of the magnets on the tabs.

5. The device for removing a cork from a bottle according to claim 1, wherein the needle comprises a hollow linear body which houses:
a piston;
a hydraulic chamber; and
a metal rod;
wherein the piston presses on the hydraulic chamber which in turn presses on the metal rod, such that the metal rod presses, in turn, on the tabs in order to overcome the force of the magnets and open the tabs.

6. The device for removing a cork from a bottle according to claim 5, comprising a button in the mobile upper casing connected to the piston housed in the needle.

7. The device for removing a cork from a bottle according to claim 1, comprising a support body configured to receive the end of a bottle where the cork is found, wherein the support body is situated on the hollow linear body between the tip of the needle and the racks.
